(19) United States
(12) Patent Application Publication
(10) Pub. No.: US 2017/0299056 A1
(43) Pub. Date: Oct. 19, 2017

(54) Oil Ring for a Piston Assembly

(71) Applicant: FEDERAL-MOGUL CORPORATION, Southfield, MI (US)

(72) Inventors: MIGUEL AZEVEDO, ANN ARBOR, MI (US); MATTHEW BELFORD, MILAN, MI (US); GREG SALENBIEN, BRITTON, MI (US)

(21) Appl. No.: 15/131,641

(22) Filed: Apr. 18, 2016

(51) Int. Cl. F16J 9/20; F16J 9/26; F16J 9/06; F16J 9/28; F02F 3/00

(52) U.S. Cl. CPC F16J 9/203; F16J 9/28; F02F 3/00; F16J 9/062; F16J 9/26

(57) ABSTRACT

A piston ring includes a body portion presenting a running surface, and a spring member disposed between the body portion and a ring groove of a piston. A running surface of the piston ring presents an upper rail, a lower rail, and a fulcrum disposed between the rails and each extending radially outwardly. An outermost tip of the fulcrum is disposed radially outwardly relative to an outermost surface of the rails, and the running surface presents a convex shape along the fulcrum. The fulcrum contacts an oil film applied to a cylinder wall as the piston reciprocates along the cylinder wall. The spring member presses the body portion of the piston ring toward the cylinder wall and causes the body portion to pivot about the fulcrum to provide for improved control of the oil film, less friction, and reduced oil consumption.

### BACKGROUND OF THE INVENTION

### 1. Field of the Invention

The invention relates to piston rings, piston assemblies including piston rings, and methods for scrapping oil along an inner surface of a cylinder of an internal combustion engine using piston rings

### 2. Related Art

Pistons for internal combustion engines are designed to contain a plurality of oil rings extending circumferentially around an upper crown for engaging an inner surface of a cylinder wall, and more specifically contact a film of lubricating oil applied to the inner surface of the cylinder wall. The piston rings are designed to seal the combustion chamber, support heat transfer from the piston to cylinder wall, and regulate oil consumption.

One type of conventional piston ring, referred to as a two-piece oil ring, includes two oil scraping rails carved into a solid body. As the piston reciprocates in the cylinder, the two-piece ring twists and thus scraps oil along the cylinder wall. Alternatively, the piston ring could comprise a three-piece assembly. In this case, as the piston reciprocates in the cylinder, the three-piece ring wipes oil along the cylinder wall. Typically, only one of the rails actively controls the oil film. The second rail, which is typically the leading rail in the direction of piston travel, is forced away from the cylinder wall by a combination of hydrodynamic forces, piston tilt, and ring twist. However, the hydrodynamic pressure generated by the oil film ahead of the rails can collapse the ring radially, rendering it less effective. The radial collapse should be counteracted by either the spring action of an expander or by designed-in expansion features in the ring itself. This outward expansion of the piston ring generates a contact pressure of the ring against the cylinder wall. However, an increase in contact pressure corresponds to an undesirable level of oil consumption, which leads to mechanical friction, decreased engine mechanical efficiency, and consequently decreased fuel economy.

### SUMMARY OF THE INVENTION

One aspect of the invention comprises a piston ring providing improved control of an oil film along an inner surface of cylinder during use in an internal combustion engine. The piston ring is expected to achieve reduced tangential tension, reduced oil consumption, less mechanical friction, increased engine mechanical efficiency, and thus increased fuel economy.

The piston ring includes a body portion and a spring member. The body portion includes an inner surface surrounding a center axis and a running surface facing opposite the center axis. The running surface presents an upper rail and a lower rail each extending radially outwardly relative to the center axis, and the rails are axially spaced from one another. The running surface also presents a fulcrum disposed between the rails. The fulcrum extends radially outwardly relative to the center axis, and an outermost tip of the fulcrum is disposed radially outwardly relative to an outermost surface of the rails. The spring member is disposed along the inner surface of the body portion and surrounds the center axis for pressing the body portion away from the center axis and causing the body portion to pivot about the fulcrum.

Another aspect of the invention provides a piston assembly including a piston ring. The piston assembly comprises an upper crown presenting an upper combustion surface and an outer diameter surface depending from the upper combustion surface and extending circumferentially about a center axis. The outer diameter surface defines at least one ring groove extending circumferentially about the center axis, and each ring groove includes an upper surface and a lower surface facing opposite one another and spaced from one another by a back surface. The piston ring is disposed in at least one of the at least one ring grooves. The piston ring comprises a body portion including an inner surface facing the back surface of the ring groove and a running surface facing opposite the back surface. The running surface of the piston ring extends axially from a top end to a bottom end. The running surface of the piston ring presents an upper rail and a lower rail each extending radially outwardly relative to the center axis and axially spaced from one another. The running surface presents a fulcrum disposed between the rails and extending radially outwardly relative to the center axis, and an outermost tip of the fulcrum is disposed radially outwardly relative to an outermost surface of the rails. The piston ring further includes a spring member disposed along the inner surface of the body portion and surrounding the back surface of the ring groove. The spring member is designed to press the body portion of the piston ring away from the back surface of the ring groove and causes the body portion of the piston ring to pivot about the fulcrum.

Yet another aspect of the invention provides a method for scrapping oil along an inner surface of a cylinder of an internal combustion engine. The method includes providing a piston assembly including a piston ring disposed in a ring groove of an upper crown. The piston ring comprises a body portion including a running surface facing the cylinder liner and an inner surface facing opposite the cylinder liner. The running surface of the piston ring extends axially from a top end to a bottom end. The running surface of the piston ring also presents an upper rail and a lower rail each extending radially outwardly relative to the center axis and axially spaced from one another. The running surface further includes a fulcrum disposed between the rails and extending radially outwardly relative to the center axis. An outermost tip of the fulcrum is disposed radially outwardly relative to an outermost surface of the rails. The piston ring also includes a spring member disposed in the ring groove of the crown portion and along the inner surface of the body portion. The method further includes moving the piston assembly along a layer of oil disposed on an inner surface of the cylinder while the fulcrum of the piston ring engages the layer of oil.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a side view of a piston assembly including a piston ring disposed in a cylinder of an internal combustion engine according to an example embodiment of the invention;

FIG. 2 is a perspective and cross-sectional view of a portion of the piston ring of FIG. 1; and

FIG. 3 is another cross-sectional view of a portion of the piston ring of FIG. 1.

### DETAILED DESCRIPTION OF EXAMPLE EMBODIMENTS

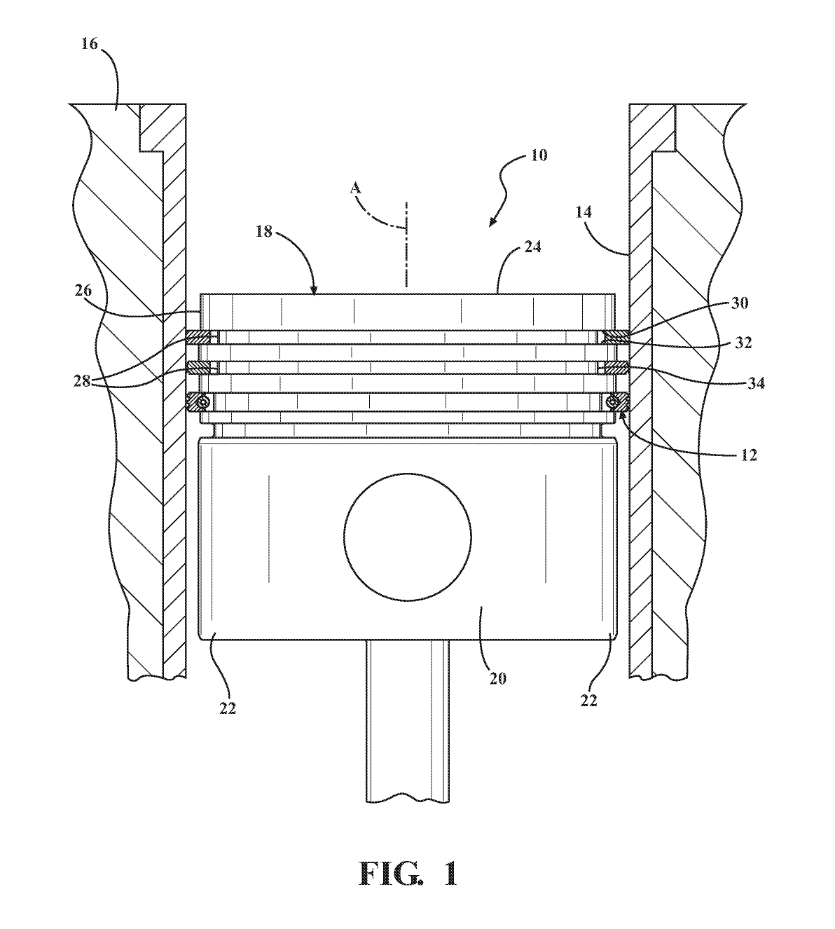

As shown in FIG. 1, the invention provides a piston assembly 10 including a piston ring 12 which is expected to improve control of an oil film 14 along an inner surface of a cylinder 16 during use in an internal combustion engine. The inner surface of the cylinder 16 is typically provided by a cylinder liner.

In the example embodiments shown in the Figures, the piston assembly 10 includes an upper crown 18, a pair of pin bosses 20 depending from the upper crown 18, and a pair of skirt panels 22 spacing the pin bosses 20 from one another. The upper crown 18, pin bosses 20, and skirt panels 22 of the piston assembly 10 could have various designs other than the design shown in FIG. 1. The upper crown 18, pin bosses 20, and skirt panels 22 are each formed of a metal material, such as an iron-based material, aluminum-based material, magnesium-based material, or another metal material. In demanding applications, steel, such as 4140 steel, is preferably used as the metal material. Magnesium alloys or aluminum alloys could be used in less demanding applications.

The upper crown 18 of the piston assembly 10 includes an upper combustion surface 24 for exposure to a combustion chamber of the engine. The upper crown 18 also includes an outer diameter surface 26 depending from the upper combustion surface 24 and extending circumferentially about a center axis A. The outer diameter surface 26 defines at least one ring groove 28 extending circumferentially about the center axis A, and typically a plurality of the ring grooves 28. Each ring groove 28 includes an upper surface 30 and a lower surface 32 facing opposite one another. The upper surface 30 and the lower surface 32 are spaced from one another by a back surface 34, and the back surface 34 faces away from the center axis A.

As shown in FIG. 1, the piston ring 12 providing for improved oil film control is disposed in one of the ring grooves 28. Alternatively, the piston ring 12 can be disposed in a plurality of the ring grooves 28 or all of the ring grooves 28. Any ring grooves 28 which do not contain the piston ring 12 of the present invention can contain a conventional oil ring or no oil ring.

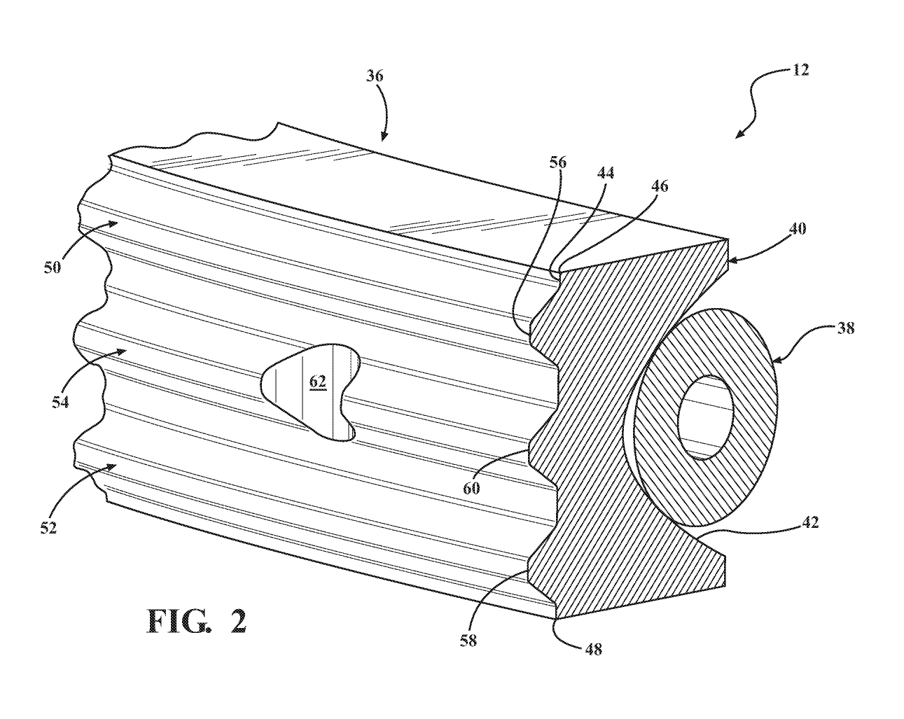

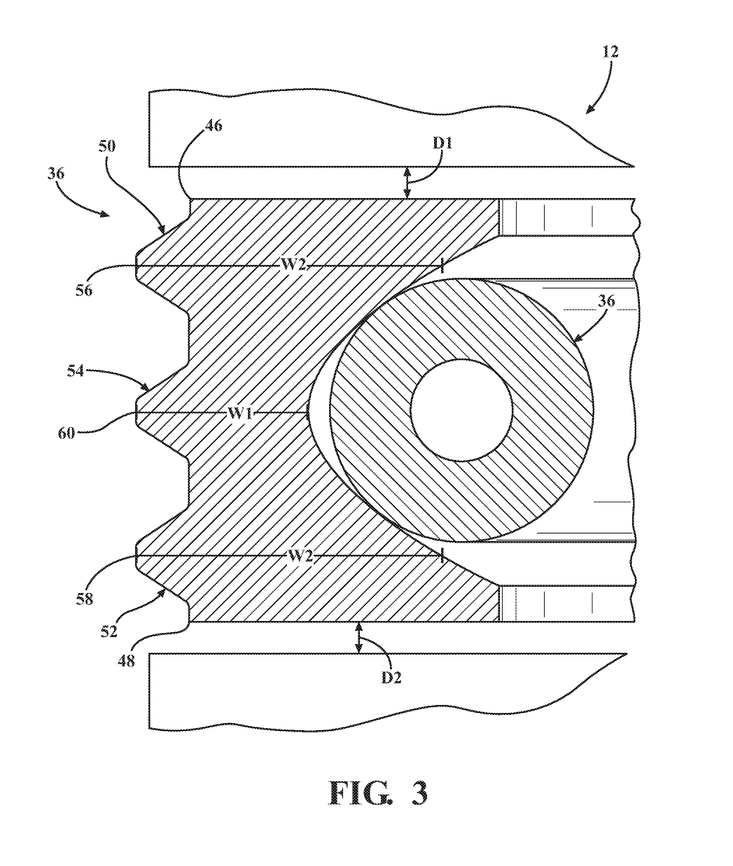

The piston ring 12 is a two-piece oil scrapper ring and thus includes a body portion 36 and a spring member 38, as shown in FIGS. 2 and 3. The body portion 36 is typically a monolithic piece of metal material, such as an iron-based or aluminum-based material. The body portion 36 includes an inner surface 40 facing the back surface 34 of the ring groove 28, and the inner surface 40 presents a concave groove 42 for retaining the spring member 38.

The body portion 36 of the piston ring 12 also includes a running surface 44 facing opposite the back surface 34 of the ring groove 28 and toward the inner wall of the cylinder 16. The running surface 44 extends axially from a top end 46 to a bottom end 48. The running surface 44 also presents an upper rail 50 and a lower rail 52 each extending radially outwardly relative to the center axis A of the piston ring 12. The upper rail 50 and the lower rail 52 are axially spaced from one another, and a third rail, referred to as a fulcrum 54, is disposed between the upper and lower rails 50, 52. The running surface 44 also includes a top land extending from the top end 46 to the upper rail 50, an intermediate land extending from the upper rail 50 to the fulcrum 54 and from the fulcrum 54 to the lower rail 52, and a bottom land extending from the lower rail 52 to the bottom end 48.

In the example embodiments shown in the Figures, the upper rail 50 includes an upper side surface extending radially outwardly from the top land and a lower side surface extending radially outwardly from the intermediate land. The upper side surface and the lower side surface of the upper rail 50 extend toward one another at an angle. The upper rail 50 also includes an outermost surface 56 spacing the upper side surface from the lower side surface, and the outermost surface 56 of the upper rail 50 is flat.

The lower rail 52 of the running surface 44 of the example embodiments also includes an upper side surface extending radially outwardly from the intermediate land and a lower side surface extending radially outwardly from the bottom land. The upper side surface and the lower side surface of the lower rail 52 extend toward one another at an angle. The lower rail 52 also includes an outermost surface 58 spacing the upper side surface from the lower side surface, and the outermost surface 58 of the lower rail 52 is flat.

As shown in the Figures, the fulcrum 54 of the running surface 44, which is disposed between the rails 50. 52, extends radially outwardly relative to the center axis A. The fulcrum 54 extends from the intermediate land to an outermost tip 60, and the outermost tip 60 of the fulcrum 54 is disposed radially outwardly relative to the outermost surfaces 56, 58 of the rails 50, 52. The running surface 44 also presents a convex shape along and adjacent the outermost tip 60 of the fulcrum 54. In the example embodiments, the fulcrum 54 presents a spherical radius along the outermost tip 60. Due to the outward radial location and the convex shape of the fulcrum 54, the body portion 36 of the piston ring 12 is able to pivot in a teeter-tooter-like fashion about the fulcrum 54 and force the rails 50, 52 against the oil film 14 as the piston assembly 10 moves longitudinally along the wall of the cylinder 16 during operation of the internal combustion engine.

In the example embodiment, the fulcrum 54 is centrally located an equal distance from the upper rail 50 and the lower rail 52. However, the fulcrum 54 could be decentralized and thus located closer to the lower rail 52 than the upper rail 50, or closer to the upper rail 50 than the lower rail 52. If the fulcrum 54 is located closer to the lower rail 52, the upper rail 50 will more forcibly interact with the oil film 14. If the fulcrum 54 is located closer to the upper rail 50, contact will preferentially be between the lower rail 52 and the oil firm 14. The fulcrum 54 is expected to act as a third rail to assist control of the oil film 14, in which case lighter tension of the spring member 38 is required to accomplish the desired oil film scrapping. The lighter tension leads to a reduction in the friction loss typically associated with piston rings, which is equivalent to or higher than the first compression ring.

Typically, there is a dimensional relationship between the outer diameter of the fulcrum 54, the inner surface 40 the body portion 36 (also referred to as the ring axial wall), the outer diameter of the rails 50, 52, and the axial clearance between the piston ring 12 and the ring groove 28. In the example embodiments, these dimensional relationships and the tilting angle of the piston assembly 10 as it slides along the cylinder 16 determine the contact angle of the upper rail 50 and lower rail 52. Preferably, the upper rail 50 and the lower rail 52 tip angle will form a convergent obtuse angle for best oil film control.

In the example embodiment, the outermost tip 60 of said fulcrum 54 and the concave groove 42 of the body portion 36 present a first width w1 therebetween. The first width w1 extends perpendicular to the center axis A. In addition, the outermost surfaces 56, 58 of the rails 50, 52 and the concave groove 42 of the body portion 36 present a second width w2 therebetween. The second width w2 also extends perpendicular to the center axis A. Also in the example embodiments, the top end 46 the running surface 44 of the piston ring 12 and the upper surface 30 of the ring groove 28 present a first clearance distance D1 therebetween. The bottom end 48 of the running surface 44 of the piston ring 12 and the lower surface 32 of the ring groove 28 present a second clearance distance D2 therebetween. The fulcrum 54 can also include an oil slot 62 for draining the lubricating oil, if desired.

To enhance boundary lubrication, the piston ring 12 typically includes a coating applied to the running surface 44 and continuously from the top end 46 to the bottom end 48 of the running surface 44. The coating is applied along each of the rails 50, 52 and the fulcrum 54. The composition of the coating is typically a premium coating selected from a chromium-based coating, a chromium-ceramic coating, a nitrided coating, a DLC coating, and a PVD coating. The DLC and PVD coatings are especially beneficial to reduce scuffing and durability.

As the piston assembly 10 slides along the cylinder 16, the spring member 38 presses the body portion 36 of the piston ring 12 against the inner surface of the cylinder 16, and more specifically against the oil film 14 applied to the inner surface of the cylinder 16. The fulcrum 54 is expected to always be either in boundary lubrication film contact with the inner surface of the cylinder 16 or ride the thin hydrodynamic oil film 14. Thus, during upward or downward movement of the piston stroke, the piston ring 12 will present, to some extent, three oil controlling features in succession. Consequently, for the same tip pressure, reduced oil consumption should be observed. Or, for the same oil consumption, a lower tangential tension of the piston ring 12 can be used, which in turn reduces oil consumption.

The spring member 38 of the piston ring 12 is disposed along the inner surface 40 of the body portion 36 and surrounds the back surface 34 of the ring groove 28. The spring member 38 is placed under a tangential tension to press the body portion 36 of the piston ring 12 away from the back surface 34 of the ring groove 28 and cause the body portion 36 of the piston ring 12 to pivot about the fulcrum 54. In the example embodiment, the spring member 38 is a helical spring, but another type of spring could be used.

Obviously, many modifications and variations of the present invention are possible in light of the above teachings and may be practiced otherwise than as specifically described while within the scope of the appended claims.

What is claimed is:

1. A piston ring, comprising:
a body portion including an inner surface surrounding a center axis and a running surface facing opposite said center axis;
said running surface presenting an upper rail and a lower rail each extending radially outwardly relative to said center axis and axially spaced from one another by a portion of said running surface,
said running surface presenting a fulcrum disposed between said rails and extending radially outwardly relative to said center axis,
an outermost tip of said fulcrum is disposed radially outwardly relative to an outermost surface of said rails; and
a spring member disposed along said inner surface of said body portion and surrounding said center axis for pressing said body portion away from said center axis and causing said body portion to pivot about said fulcrum.

2. The piston ring of claim 1, wherein said running surface of said piston ring is convex along said fulcrum.

3. The piston ring of claim 1, wherein said fulcrum presents a spherical radius.

4. The piston ring of claim 1, wherein said inner surface of said body portion presents a concave groove for retaining said spring member.

5. The piston ring of claim 4, wherein an outermost tip of said fulcrum and said concave groove of said body portion present a first width therebetween, and said first width extends perpendicular to said center axis.

6. The piston ring of claim 5, wherein said outermost surface of each of said rails and said concave groove of said body portion present a second width therebetween, and said second width extends perpendicular to said center axis.

7. The piston ring of claim 1, wherein said fulcrum is centered between said lower rail and said upper rail.

8. The piston ring of claim 1, wherein said fulcrum is not centered between said lower rail and said upper rail.

9. The piston ring of claim 1, wherein said running surface of said body portion extends axially from a top end to a bottom end;
said running surface includes a top land extending from said top end to said upper rail, an intermediate land extending from said upper rail to said fulcrum and from said fulcrum to said lower rail, and a bottom land extending from said lower rail to said bottom end;
said upper rail includes an upper side surface extending radially outwardly from said top land, said upper rail includes a lower side surface extending radially outwardly from said intermediate land, said upper side surface and said lower side surface of said upper rail extend toward one another at an angle, said upper rail includes an outermost surface spacing said upper side surface from said lower side surface, and said outermost surface of said upper rail is flat;
said lower rail includes an upper side surface extending radially outwardly from said intermediate land, said lower rail includes a lower side surface extending radially outwardly from said bottom land, said upper side surface and said lower side surface of said lower rail extend toward one another at an angle, said lower rail includes an outermost surface spacing said upper side surface from said lower side surface, and said outermost surface of said lower rail is flat.

10. The piston ring of claim 1, wherein a coating is applied to said running surface of said body portion, and said coating is selected from a chromium-based coating, a chromium-ceramic coating, a nitrided coating, a DLC coating, and a PVD coating.

11. The piston ring as set forth in claim 1 wherein said body portion is a monolithic piece of metal material;
said inner surface of said body portion presents a concave groove for retaining said spring member;
said running surface of said body portion extends axially from an top end to a bottom end,
said running surface includes a top land extending from said top end to said upper rail, an intermediate land extending from said upper rail to said fulcrum and from said fulcrum to said lower rail, and a bottom land extending from said lower rail to said bottom end;
said upper rail includes an upper side surface extending radially outwardly from said top land, said upper rail includes a lower side surface extending radially outwardly from said intermediate land, said upper side surface and said lower side surface of said upper rail extend toward one another at an angle, said upper rail includes an outermost surface spacing said upper side surface from said lower side surface, and said outermost surface of said upper rail is flat;
said lower rail includes an upper side surface extending radially outwardly from said intermediate land, said lower rail includes a lower side surface extending radially outwardly from said bottom land, said upper side surface and said lower side surface of said lower rail extend toward one another at an angle, said lower rail includes an outermost surface spacing said upper side surface from said lower side surface, and said outermost surface of said lower rail is flat;
said fulcrum extends from said intermediate land to an outermost tip, and said fulcrum presents a spherical radius along said outermost tip;
said outermost tip of said fulcrum and said concave groove of said body portion present a first width therebetween, and said first width extends perpendicular to said center axis;
said outermost surface of each of said rails and said concave groove of said body portion present a second width therebetween, and said second width extends perpendicular to said center axis;
said running surface of said body portion is convex along said fulcrum;
said spring member is a helical spring;
a coating is applied to said running surface of said body portion, said coating extends continuously from said top end along said rails and said fulcrum to said bottom end; and
said coating is selected from a chromium-based coating, a chromium-ceramic coating, a nitrided coating, a DLC coating, and a PVD coating.

12. A piston assembly, comprising:
an upper crown presenting an upper combustion surface and an outer diameter surface depending from said upper combustion surface and extending circumferentially about a center axis;
said outer diameter surface including at least one ring groove extending circumferentially about said center axis, each ring groove including an upper surface and a lower surface facing opposite one another and spaced from one another by a back surface, said back surface facing away from said center axis;
a piston ring disposed in at least one of said at least one ring grooves;
said piston ring comprising a body portion including an inner surface facing said back surface of said ring groove and a running surface facing opposite said back surface;
said running surface of said piston ring extending axially from an top end to a bottom end;
said running surface of said piston ring presenting an upper rail and a lower rail each extending radially outwardly relative to said center axis and axially spaced from one another;
said running surface presenting a fulcrum disposed between said rails and extending radially outwardly relative to said center axis, an outermost tip of said fulcrum is disposed radially outwardly relative to an outermost surface of said rails; and
said piston ring further including a spring member disposed along said inner surface of said body portion and surrounding said back surface of said ring groove for pressing said body portion of said piston ring away from said back surface of said ring groove and causing said body portion of said piston ring to pivot about said fulcrum.

13. The piston assembly of claim 12, wherein said top end of said running surface of said piston ring and said upper surface of said ring groove present a first clearance distance therebetween, said lower end of said running surface of said piston ring and said lower surface of said ring groove present a second clearance distance therebetween.

14. The piston assembly of claim 12, wherein said top end of said running surface of said piston ring and said upper surface of said ring groove present a first clearance distance therebetween, said lower end of said running surface of said piston ring, and said lower surface of said ring groove present a second clearance distance therebetween.

15. The piston assembly of claim 12, wherein said running surface of said piston ring is convex along said fulcrum.

16. The piston assembly of claim 12 including a pair of pin bosses depending from said upper crown and each defining a pin bore, the pin bosses being spaced from one another by skirt panels;
wherein said body portion of said piston ring is a monolithic piece of metal material;
said inner surface of said body portion presents a concave groove for retaining said spring member;
said running surface of said body portion extends axially from an top end to a bottom end,
said running surface includes a top land extending from said top end to said upper rail, an intermediate land extending from said upper rail to said fulcrum and from said fulcrum to said lower rail, and a bottom land extending from said lower rail to said bottom end;
said upper rail includes an upper side surface extending radially outwardly from said top land, said upper rail includes a lower side surface extending radially outwardly from said intermediate land, said upper side surface and said lower side surface of said upper rail extend toward one another at an angle, said upper rail includes an outermost surface spacing said upper side surface from said lower side surface, and said outermost surface of said upper rail is flat;
said lower rail includes an upper side surface extending radially outwardly from said intermediate land, said lower rail includes a lower side surface extending radially outwardly from said bottom land, said upper side surface and said lower side surface of said lower rail extend toward one another at an angle, said lower rail includes an outermost surface spacing said upper side surface from said lower side surface, and said outermost surface of said lower rail is flat;
said fulcrum extends from said intermediate land to an outermost tip, and said fulcrum presents a spherical radius along said outermost tip;
said outermost tip of said fulcrum and said concave groove of said body portion present a first width therebetween, and said first width extends perpendicular to said center axis;
said outermost surface of said rails and said concave groove of said body portion present a second width therebetween, and said second width extends perpendicular to said center axis;
said top end of said running surface of said piston ring and said upper surface of said ring groove present a first clearance distance therebetween;
said lower end of said running surface of said piston ring and said lower surface of said ring groove present a second clearance distance therebetween;
said running surface of said piston ring is convex along said fulcrum;
said spring member is a helical spring;
a coating is applied to said running surface of said body portion, said coating extends continuously from said top end along said rails and said fulcrum to said bottom end; and
said coating is selected from a chromium-based coating, a chromium-ceramic coating, a nitrided coating, a DLC coating, and a PVD coating.

17. A method for scrapping oil along an inner surface of a cylinder of an internal combustion engine, comprising the steps of:
providing a piston assembly, the piston assembly including a piston ring disposed in a ring groove of an upper crown, the piston ring comprising a body portion including a running surface facing the cylinder liner and an inner surface facing opposite the cylinder liner, the running surface of the piston ring extending axially from a top end to a bottom end, the running surface of the piston ring presenting an upper rail and a lower rail each extending radially outwardly relative to the center axis and axially spaced from one another, the running surface presenting a fulcrum disposed between the rails and extending radially outwardly relative to the center axis, an outermost tip of the fulcrum is disposed radially outwardly relative to an outermost surface of the rails, and the piston ring further including a spring member disposed in the ring groove of the crown portion and along the inner surface of the body portion; and
moving the piston assembly along an layer of oil disposed on the inner surface of the cylinder liner while the fulcrum of the piston ring engages the layer of oil.

18. The method of claim 17, wherein the spring member presses the body portion of the piston ring toward the cylinder liner and causes the body portion to pivot about the fulcrum during the step of moving the piston assembly along layer of oil. The piston ring of claim 18, wherein said upper rail and the lower rail of the piston ring present an obtuse angle therebetween when the body portion of the piston ring pivots about the fulcrum.

20. The method of claim 17, wherein the running surface of the piston ring is convex along the fulcrum.
